(19) United States
(12) Patent Application Publication
(10) Pub. No.: US 2014/0136477 A1
(43) Pub. Date: May 15, 2014

(54) CONDITIONING PROCESS MONITOR AND ASSESMENT SYSTEM AND METHOD

(71) Applicants: Jeffrey Douglas Young, Houston, TX (US); Christopher Norton Davies, League City, TX (US); Daniel Leonard Lamper, Richmond, TX (US); Alan Justin Stepp, Dallas, TX (US)

(72) Inventors: Jeffrey Douglas Young, Houston, TX (US); Christopher Norton Davies, League City, TX (US); Daniel Leonard Lamper, Richmond, TX (US); Alan Justin Stepp, Dallas, TX (US)

(21) Appl. No.: 14/015,449

(22) Filed: Aug. 30, 2013

Related U.S. Application Data
(60) Provisional application No. 61/695,381, filed on Aug. 31, 2012.

(51) Int. Cl. G06F 17/30

(52) U.S. Cl. CPC G06F 17/30312
USPC 707/609

(57) ABSTRACT

A method for monitoring and assessing a conditioning/reconditioning process of products, such as new or used cars of a dealership, includes capturing images of products as they progress through stations of the conditioning process, communicating each captured image, in real time when captured, together with a timestamp for the capture of the image, to a central repository, creating a record from each first image and timestamp corresponding to each new or used product prior to the conditioning process, updating the record with each subsequent image and timestamp during the conditioning process (e.g., before and after each next work station in the conditioning progression), and generating reports by the central repository, responsive to requests, in respect of at least portions of the record.

### CROSS-REFERENCE TO RELATED APPLICATIONS

The present application is a conversion and has benefit of priority of U.S. Provisional Patent Application No. 61/695,381, titled “Conditioning Process Monitor and Assessment System and Method”, filed Aug. 31, 2012, which application is co-pending and has at least one same inventor of the present application and is herein incorporated by this reference.

### TECHNICAL FIELD

The invention generally relates to tools for tracking product being conditioned for sale or delivery, and more specifically relates to timeline monitors for identifying, tracking and timing new and used products undergoing conditioning service work, for example, such as new or pre-owned automobiles of an auto dealership.

### BACKGROUND

Products to be offered for sale often require conditioning prior to display at the seller's facilities. Once sold, the products may also require conditioning before delivery to the buyer. Conditioning (also referred to as reconditioning, particularly in the case of used or pre-owned products) often includes several segregable tasks, such as cleaning, unpacking, maintenance, repair, tuning and others.

Automobiles are one type of products that can often require certain conditioning work in order to make them most presentable to potential buyers and purchasers. Conditioning may be required for both new and pre-owned automobiles. New autos coming to a car dealer's lot often have accumulated road grime and blemishes or minor damage during transit to the dealer's lot, and also may be delivered variously coated, covered or packed and needing certain installation, maintenance or repair. To ready the auto for display, maintain it on the lot, and deliver it to a buyer in ready condition, service work (i.e., conditioning) is typically required for the auto. Similarly with pre-owned cars, the seller must typically service the car by cleaning, fixing, repairing, replacing, and maintaining the car for display and delivery to a buyer.

As a result, one or more conditioning operations must be performed for products before display or sale. The seller may maintain facilities and personnel to perform conditioning of products, or the seller may engage other servicers/vendors to perform at least some of the various conditioning tasks/jobs that may be required for the products. In the case of automobiles, the car dealership may sell new cars, take in pre-owned autos on trade, and also may sell those and other pre-owned autos on a retail basis. The new cars must usually be conditioned before presentation to customers and delivery to buyers. The pre-owned cars also often must be conditioned (i.e., reconditioned) before they can be presented to customers and delivered to buyers.

Dealerships are typically organized into various work groups (or “stations”) for performing respective conditioning tasks or jobs. The stations are often physically segregated in location at the dealership site, and can also, in whole or part, be remotely situated off the dealership's premises. The dealership may either employ persons or contract with others as vendors/servicers to the dealer, to provide the work performed for the station. Each work group or station performs one or more specialized tasks requiring particular activities or processes for the conditioning/reconditioning.

Automobiles, both new and used, often must progress through several stations for completion of conditioning/recondition. This can result in a stream of vehicles passing through series of respective conditioning stations at any instant. For instance, a pre-owned car might require improvement work performed on the engine and drive train, the interior, paint and body and accessories (wheels), or a new car might require similar or other prep work, such as removal of packing/films, cleaning, touch up, wheel balancing or other maintenance, to make the car presentable. These separate activities or processes can each be a separate conditioning station of the dealership. The particular arrangement of stations for the dealership in any instance, of course, depends on the needs of the dealer and its desired segregation of stations.

Conventionally, autos progressing through the series of various conditioning/reconditioning stations have been manually identified, tracked, and monitored by the dealership. A dealer employee (often the salesperson or another at the dealership) has had to personally observe the vehicle at the relevant stations or telephone or make inquiry in person, by telephone or other communication to the applicable vendor/servicer of each station. Thus, the conventional manual approach to identifying, tracking and monitoring in the conditioning process can require significant time and effort of dealer employees, as well as of the vendor/servicer, detracting from other productive activities.

The conventional manual approach in the conditioning process has had limited Assessment of stations, results, timing, efficiency and of the conditioning process, and accountability of vendors/servicers and employees involved in the conditioning process, has conventionally been limited. Personally observed or communicated status of cars at stations may be misunderstood, misinterpreted, or inaccurate. Additionally, mistakes may be made in identifying specific autos or the status. Even when status and information is accurate, the conventional manual approach results in delays and delayed information. Other issues, such as time and work management of dealer personnel, departments and the like, and vendors/servicers and their respective personnel, are also not recognized and, even when recognized, cannot be timely addressed when presented in real-time because of the delays and lack of ready accountability.

It would, therefore, be desirable to provide new and improved systems and methods for real-time and accurate identification, tracking, and monitoring of products during the conditioning and re-conditioning process. It would further be desirable to provide systems and methods for streamlining communications among dealers and vendor/servicers during conditioning and re-conditioning. It would also be desirable to provide more systems and methods for assessing and analyzing efficiency and accountability of conditioning and re-conditioning, and relevant stations, steps, timing and personnel. Even more, it would be desirable to provide such systems and methods for products such as automobiles, both new and used, of an automobile dealership.

### SUMMARY

An embodiment of the invention is a system for monitoring a conditioning process for a product. The system is configured to communicate over a data network. The system includes a central computer for receiving product images and image timestamps of the product from the data network, a database connected to the central computer, for storing product images and image timestamps received by the central computer, and a management unit communicatively connected to the central computer, the management unit creates and updates a respective record of the database for the product, responsive to receipts by the central computer.

In further aspects, the system includes a manager device communicatively connected to the central computer. The management unit, responsive to request of the manager device received by the central computer, communicates data to the manager device corresponding to the record then stored by the database for the product.

In another aspect, the system includes an image capture device communicatively connected to the central computer by the network, for communicating at least one of the product images and at least one of the image timestamps corresponding to the at least one of the product images, to the central computer over the network.

Another embodiment of the invention is a method for monitoring a conditioning process for a product. The method includes capturing a first image of the product, timestamping the first image, saving the first image, together with timestamp, in a record of a database, capturing a second image of the product during the conditioning process, timestamping the second image, and saving the second image, together with timestamp, in the record of the database.

In further aspects, the method includes communicating the first image and timestamp over a network, in real time, receiving the first image and timestamp, creating the record in the database for the first image and timestamp, communicating the second image and timestamp over the network, in real time, receiving the second image and timestamp, and updating the record in the database for the second image and timestamp.

In yet further aspects, the method includes capturing a next image of the product at different time during the conditioning process, timestamping the next image, communicating the next image and timestamp over the network, in real time, receiving the next image and timestamp, updating the record in the database for the next image and timestamp, and repeating the steps of capturing the next image, timestamping the next image, communicating the next image and timestamp, receiving the next image and timestamp, and updating the record in the database of the next image and timestamp, in succession and each at different time in the conditioning process until the conditioning process is completed.

In other aspects, the method includes receiving a request from a requestor over the network, for a data representing at least a portion of the record, generating a report responsive to the request, and communicating the report over the network to the requestor.

In even further aspects, the method includes repeating the steps of receiving the request, generating the report, and communicating the report for the record as then-updated at the time of the step of receiving the request.

### BRIEF DESCRIPTION OF THE DRAWINGS

The present invention is illustrated by way of example and not limitation in the accompanying figures, in which like references indicate similar elements, and in which:

FIG. 1 illustrates a system for monitoring a conditioning process of products, such as may be employed by an automobile dealership for new and/or used automobiles, for identifying, tracking and timing new and used products undergoing conditioning service work, according to certain embodiments of the invention;

FIG. 2 illustrates a system for management of a conditioning process for products, operable by or on behalf of a dealership, including a central system and database, according to certain embodiments;

FIG. 3 illustrates an office system for management and reporting in a conditioning process for products, for collecting and recording image and related data representing products at stations in the conditioning process, according to certain embodiments of the invention;

FIG. 4 illustrates an image capture device in use for collecting and reporting in a conditioning process for products, according to certain embodiments of the invention;

FIG. 5 illustrates an exemplary capture system for capturing product images and wirelessly communicating with a system for management of a conditioning process for the product, according to certain embodiments of the invention;

FIG. 6 illustrates a digital camera device having a transmitter for capturing images of products and communicating with a system for management of a conditioning process for the products, according to certain embodiments of the invention;

FIG. 7 illustrates menu screens of a capture device for capturing and communicating product images, and for communicating about products, with a system for management of a conditioning process for the products, according to certain embodiments of the invention; and

FIG. 8 illustrates a method for identifying, tracking and timing new and used products undergoing conditioning service work, according to certain embodiments of the invention.

### DETAILED DESCRIPTION

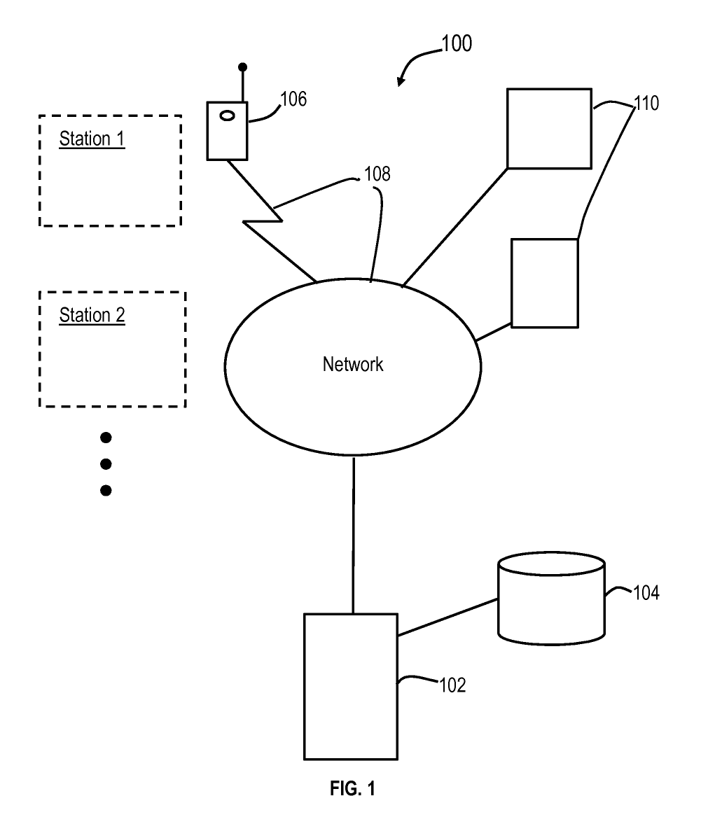

Referring to FIG. 1, a system 100 for monitoring a conditioning process includes a centralized management device 102. The centralized management device 102 includes or is communicatively connected to a record storage 104. One or more image capture device 106 can communicatively connect to the centralized management device 102. One or more network 108 communicatively connects the image capture device 106 to the centralized management device 102. The system 100 can, but need not necessarily, include one or more manager device 110. The manager device 110 can communicatively connect to the centralized management device 102, such as by the network 108 or a link, combination of links, or particular subset thereof.

In operation, the one or more image capture device 106 each photograph one or more image of a product, such as an automobile, at a respective station (shown in phantom) in the conditioning process for the product. The image capture device 106 timestamps and communicates the photograph, such as by wireless transmission, over the network 108, to the centralized management device 102. The centralized management device 102 receives the photograph over the network 108, and saves the photograph, together with the timestamp, in the record storage 104. The centralized management device 102 creates a new record in the record storage 104 for each respective product upon receiving a first photograph of the product. The record for the product is then updated with any and each next photograph, together with respective timestamp, in the record storage 104. Upon request communicated over the network 108 by any of the one or more manager device 110 to the centralized management device 102, the centralized management device 102 controls the record storage 104 in accordance with the request to generate a report. The report includes, for example, information of one or more record then-stored in the record storage 104. For example, reports may include relevant photograph(s), timeline(s), other data of the record storage 104 for a particular product, products or other data, or summaries thereof as applicable, representing stations, status of product(s) of station(s), and other status and aspects of the conditioning process.

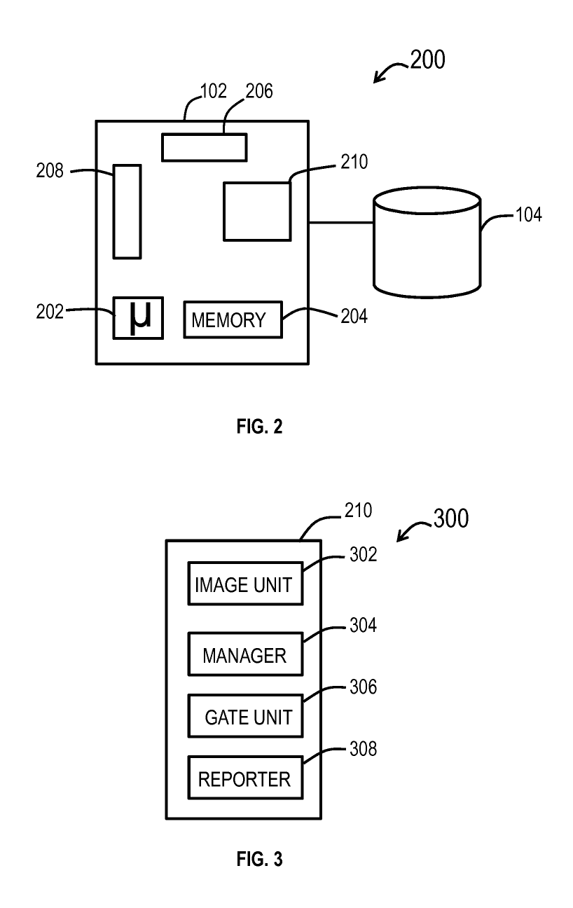

Referring to FIG. 2 in conjunction with FIG. 1, a system 200 for management of a conditioning process includes the centralized management device 102. The centralized management device 102 includes or communicatively connects to a controller 210 and memory 204. The centralized management device 102 also includes a communicator unit 206 and an image receiver 208. A management unit 210 of the centralized management device 102 is communicatively connected to the communicator unit 206 and the image receiver 208. The management unit 210 also communicatively connects to the records storage 104.

The records storage 104 is a database, for example, a relational database, included in or communicatively connected to, and controlled by, the centralized management device 102. The records storage 104 includes respective records created, stored, managed, and updated in the records storage 104 by the management device 102. Each record includes an identifier of a respective product, such as a particular automobile, including image data of the product and a timestamp of the image data. The image data represents a photograph of the product, such as a digital photograph. Image data for each product is first captured when the product comes into the product dealer's possession or control. That image data is associated with a time stamp corresponding to the time that the image data is captured. Upon receipt of the image data by the centralized management device 102, the management device 102 creates a record for the product corresponding to the image data and time stamp and saves the record in the records storage 104. As the product progresses through a conditioning process, additional images may be captured for the product and the respective image data together with timestamp communicated to the centralized management device 102. On receipt of successive image data and timestamp for the product, the centralized management device 102 searches the records storage 104 for the relevant record representing the product and adds the image data and timestamp to the record and saves the record in the records storage 104.

Referring to FIG. 3, in conjunction with FIGS. 1 and 2, an office system 300 for managing and reporting in a conditioning process includes the management unit 210 of the centralized management device 102. The management unit 210 includes an image unit 302. The image unit 302 is hardware, software stored in memory, or combinations, controlled by the controller 202, for receiving from image receiver 108 and manipulating image data representing products for storage in the record storage 104. If and as may be required or desirable in the embodiment, each image data is translated and formatted as required for storage in the record storage 104.

The management unit 210 also includes a manager 304. The manager 304 is communicatively connected to the image unit 302 and the record storage 104. The manager 304 is hardware, software stored in memory, or combinations, controlled by the controller 202, for managing records of the record storage 104. The manager 304 creates and stores a respective record of the record storage 104 for each product, such as each automobile, of the conditioning process, and then updates, as applicable, the respective record in the record storage 104.

A gate unit 306 of the management unit 210 is communicatively connected to the manager 304 and to the communicator unit 206. The gate unit 306 is hardware, software stored in memory, or combinations, controlled by the controller 202, for interfacing communications over the network 208 with respective ones of the manager device 110. The gate unit 306 can also, but need not necessarily, interface communications over the network 208 with the manager device 110 for authorization and authentication of the manager device 110, for example, by restricting or allowing particular access to certain records, reports, or information stored in the record storage. In certain embodiments, the gate unit 306 serves an authorization/authentication screen display or web page to each manager device 110 requesting access. If authorization/authentication is not required by the gate unit 306 or if required and successful, the gate unit 306 serves an information request or search display or web page to the manager device 110. The manager device 110 communicates via the display or web page by interactive input to a search or similar element and sending the input to the gate unit 306 over the network 108.

The management unit 210 also includes a reporter 308. The reporter 308 is communicatively connected to the manager 304 and the gate unit 306. The gate unit 306 is hardware, software stored in memory, or combinations, controlled by the controller 202, for creating, generating and formatting reports of respective records and summaries of records of the records storage 104 in response to requests of any manager device 110 to the gate unit 306 for the report. The reporter 308 communicates data files representing the report to the gate unit 306, and the gate unit 306 delivers the report to the relevant manager device 110. The reporter 308 can, but need not necessarily, perform calculations and generate graphical display data representing the conditioning process, one or more respective station, one or more product, and other information based on data of the records.

In a non-exclusive example, the centralized management device 102 is a computer, for example, a desktop or server computer with communication capabilities required for communications over the network 108. the records storage 104 is a relational database program stored in memory of the management device 102 or communicatively connected to the management device 102 by the network 108 or otherwise. Each image capture device 106 is a digital camera equipped computer, data-enabled cellular telephone, tablet computer, or other, capable of capturing an image of the product, such as an automobile, and time stamping the resulting image data. Each image capture device 106 also includes or can be communicatively connected to the network 108, for wirelessly communicating the image data and timestamp to the management device 102 via the network 108. Each manager device 110 is a computer, for example, a desktop computer, laptop, tablet, smartphone, personal digital assistant, or other processing device capable of communicating over the network 108 to the centralized management device 102. The network 108 includes a wired data communications network for communicatively connecting the centralized management device 102 to the one or more manager device 110 and a wireless data communications network for communicatively connecting the centralized management device 102 to the one or more image capture device 106. Examples of the wired and wireless networks include any link or telecommunications network, or combination of such links and/or networks, or pluralities of different links or networks, for example, a packet-switched data network (e.g., Internet, intranet, local area network (LAN), wide area network (WAN) or virtual private network (VPN)), a circuit switched network (e.g., public switched telephone network (PSTN)), a cellular telephone network, or a wireless data network (e.g., cellular data, WiFi, WLAN, GPS, infrared, satellite, radio frequency, or other).

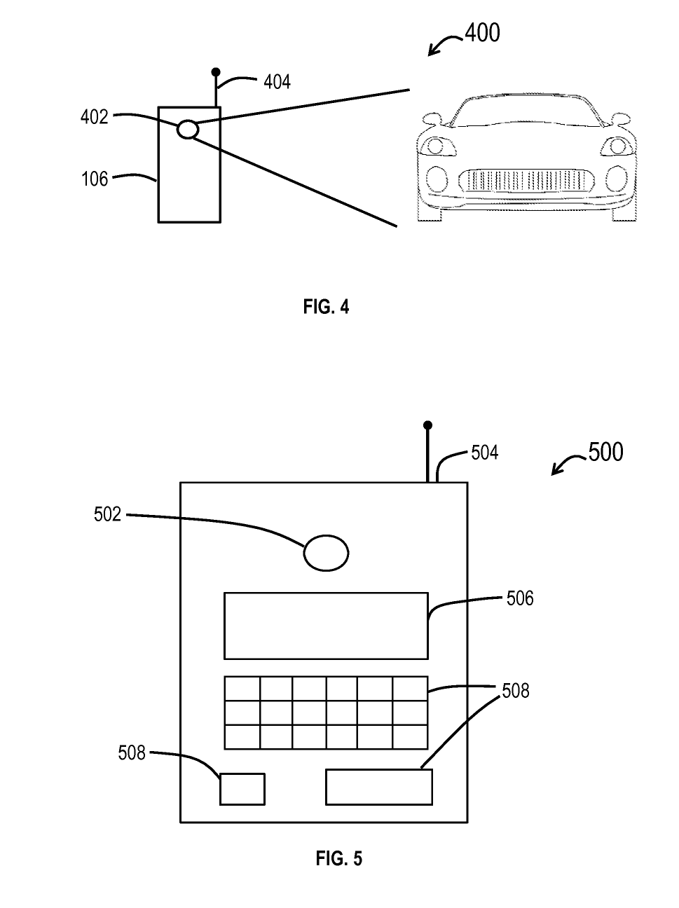

Referring to FIG. 4, in conjunction with FIG. 1, a system 400 for capturing an image during a conditioning process for a product, such as an automobile, includes the image capture device 106. The image capture device 106 includes a camera 402 and a transmitter 404. The camera 402 is, for example, a digital camera. The transmitter 404 is shown as an integral part of the device 106, however, it may be a separate or separable device communicatively connected to the camera 402. The transmitter 404 is configured to communicatively connect to the network 108 for transmitting image data captured by the camera 402 to the centralized management device 102.

Referring to FIG. 5, in conjunction with FIGS. 4 and 1, an exemplary capture system 500, for example, which can but need not necessarily serve as the image capture device 106, includes a camera 502, an output display 506, and one or more input device 508. The capture system 500 also includes a transmitter 504 configured to communicatively connect to the network 108, such as by a public wireless network or a private wireless network.

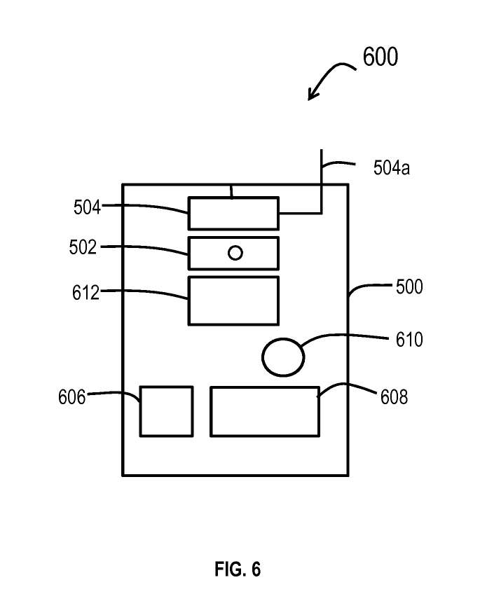

Referring to FIG. 6, in conjunction with FIGS. 1, 4 and 5, a digital camera device 600 according to the exemplary capture system 500 includes the camera 502 and transmitter 504. The output display 506 and input device 508 are not shown in FIG. 6. The device 600 also includes a processor 606, memory 608, and a timer 610. The device 600 further includes a camera control unit 612. The control unit 612 is hardware, software program stored in memory, or combinations. The control unit 612 is processed by the processor 606, and operates to collect image data representing an image captured by the camera 502, timestamp the image data with the time of collection from the timer 610, and controls the transmitter 504 to transmit the image data together with the timestamp, over the network 108.

In a certain non-exclusive example, the transmitter 504 includes a radio, such as a cellular radio, a WiFi access modem, or both. The radio is configured to transmit (and as applicable, exchange) data wirelessly over the network 108. In the case of cellular access, the transmitter 504 communicates the image data and timestamp, by an antenna 504a of the transmitter 504, to a cell site and the cell site communicates with an applicable base station of the cellular communications provider. As applicable in the embodiment, the cellular communication is forwarded to the provider's mobile switching center and thereon through applicable network routers and infrastructure devices and links of the network 108, to the centralized management unit 102. In the case of WiFi access, the transmitter 504 communicates the image data and timestamp to a wireless access point of the network 108, and the network 108 routes the communication on to the centralized management unit 102 via applicable network routers and infrastructure devices and links of the network 108.

In the non-exclusive example, the camera 502 is a digital camera and collects digital image data representing the image of the product or is an analog camera and the control unit 612 converts analog capture to digital data for image data transmitted over the network 108. The control unit 612 obtains the image data from the camera 502 on capture, obtains a time for the capture from the timer 610, and generates and formats the image data and timestamp for transmission by the transmitter 504. In certain alternatives, the control unit 612 can format or otherwise manipulate the data of the image as captured by the camera 502, for example, if required for efficient transmission over the network 108 or otherwise. The control unit in certain embodiments is an application software program stored in memory of the device 600, such as an “app.” The software program may, for example, be loaded into the memory by download from the centralized management computer 102 or other source as will be understood and according to the particular embodiment.

The control unit 612 additionally, on selective input to the digital camera device 600 (as hereafter described), communicates via the transmitter 504 with centralized management unit 102 over the network 108. In the communication, the control unit 612 makes request to the centralized management unit 102, corresponding to the selective input to the digital camera device 600. The centralized management unit 102 returns to the control unit 612 select data representing a product, such as an automobile, then present in a relevant record of the records storage 104. Additionally, based on the particular request by the camera device 600, select data representing the product, summaries of select data representing the product, and/or other data, graphics, or images representing the product, the system 100, work progress during conditioning, or other data or information, can be delivered to the camera device 600 by the centralized management device 102 over the network 108. The camera device 600, if equipped with required output elements, can display or otherwise output text, graphics, audio, images, and other content and information corresponding to the response and representing the product and conditioning process.

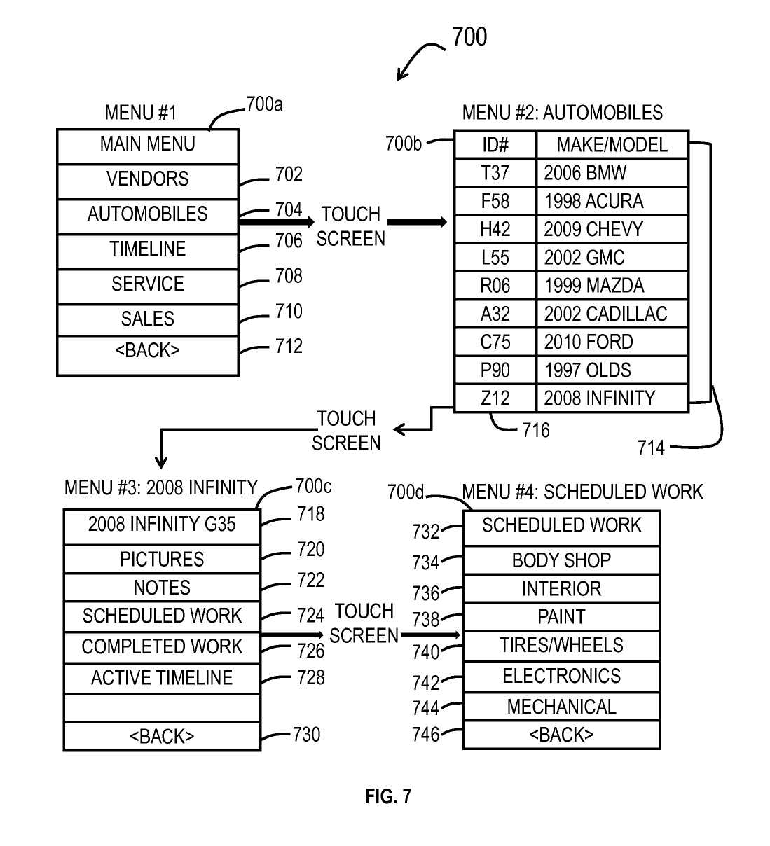

Referring to FIG. 7, in conjunction with FIGS. 5 and 6, an exemplary sequence of operations of the capture system 500 (i.e., also the digital camera device), during communications with the centralized management device 102 regarding a product, is initiated with a menu screen 700 displayed in the output display 506 of the capture system 500 (i.e., the digital camera device 600 of FIG. 6). Input selection of any respective item of the menu screen 700 (which, for example, includes 700a-700d, as hereinafter described) can direct the system 500/device 600 to communicate a request to the centralized management device 102 over the network 108, if the request is for data or information then-available from the centralized management device 102. The centralized management device 102 can then respond over the network 108 by delivering to the system 500/device 600 particular data representing the product in respect of the request and the subject matter of the request.

The menu screen 700 is generated by the control unit 612 on processing by the processor 606. The menu screen 700 illustrated in FIG. 7 is merely intended as one possible example, from among a variety of others, for layout, graphics, and items for selection, in a sequence of the menu screen 700 that may appear in the output display 506. In the non-exclusive example, the menu screen 700 includes a main menu screen 700a, appearing first on initial processing of the control unit 612. The main menu screen 700a includes one or more items, such as Vendors 702, Automobiles 704, Timeline 706, Service 708, Sales 710, and Back 712. Any one of the items may be selected by input to the capture system 500 (i.e., digital camera device 600), for example, by key, button or touch screen input device thereof, as applicable.

If Automobiles 704 is selected by input to the system 500/device 600 in the non-exclusive example, a corresponding item screen 700b is displayed in the output display 506. The item screen 700b includes a product list 714 of respective products for selection for further options regarding the selected product. If 2008 Infinity with ID Z12 is next selected by input to the system 500/device 600 for purposes of the example, a corresponding option screen 700c is next displayed by the system 500/device 600.

The option screen 700c, in the case of the non-exclusive example, includes a Product Identifier 718, and one or more selectable items, such as Pictures 720, Notes 722, Scheduled Work 724, Completed Work 726, and Active Timeline 728, as well as Back 730 (e.g., return to prior menu). Each of the selectable items of the option screen 700c can lead, if selected by input to the system 500/device 600, to display of specific elements representing the product and/or additional screens, including, as may be applicable, for input selection of specific elements for display.

Further in the non-exclusive example, input selection of Scheduled Work 724 of the option screen 700c next displays a scheduled work screen 700d. The example work screen 700d includes selectable items which, if selected by input, can lead to specific elements representing the product and/or additional screens. These selectable items include Scheduled Work 732, Body Shop 734, Interior 736, Paint 738, Tires/Wheels 740, Electronics 742, and Mechanical 744. Input selection of any respective one of these items leads to subsequent screen displays of data and summaries of data representing the product and the particular subject matter of the selected item. Although not shown in FIG. 7, input for the item Mechanical 744 may give details of mechanical work to be performed in conditioning of the product, as well as details of whether all or portions of the work has been completed, relevant timelines therefor, and other information.

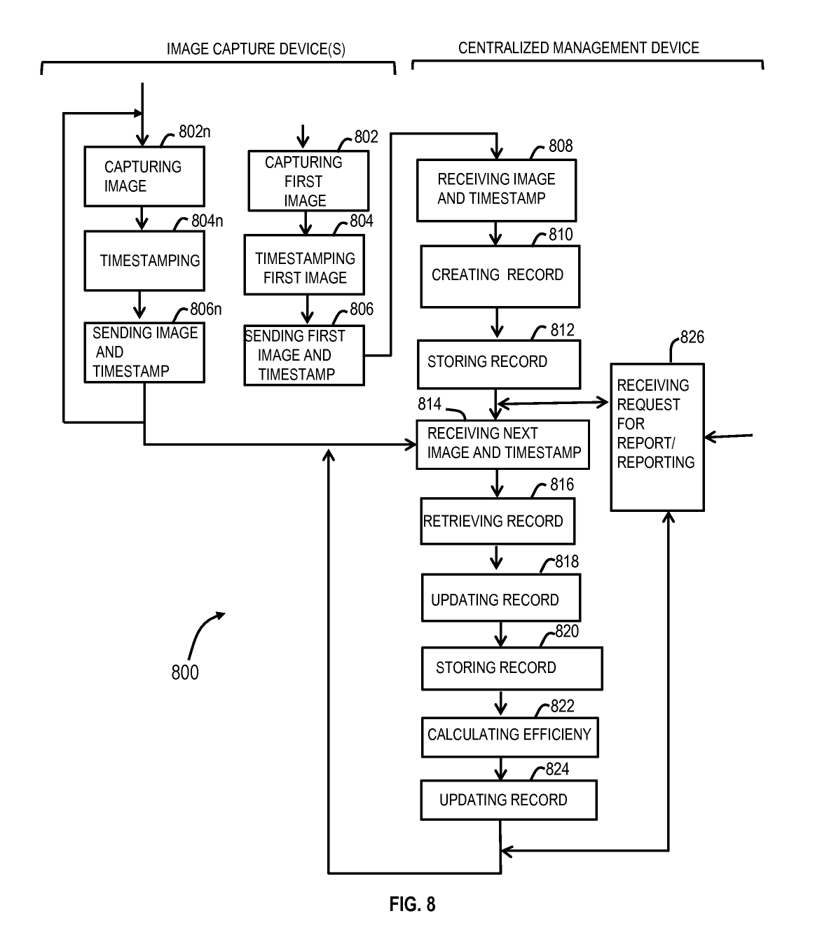

Referring to FIG. 8, a method 800 for monitoring a conditioning process for a product, such as a new or used automobile, commences with a step of capturing an image 802 of the product received. An automobile dealership, as an example, captures an image of the auto in the step 802 when the dealer first receives, is delivered or otherwise obtains the auto (e.g., when a new car comes to the dealer's lot, on accepting a used car for trade-in, etc.). The image is captured in the step 802 by a digital camera or other capture device equipped with communication capabilities, such as the image capture device of FIG. 1, or the capture system 500 or digital camera device 600 of FIG. 5 or 6, respectively. The capture device is configured, such as by a control unit 612 or other hardware or software program stored in memory providing similar operation, to associate a timestamp with the captured image. The captured image is timestamped by the device in a step 804.

In a step 806, the capture device communicates the image, such as digital image data representing the captured image, and the timestamp, over a network. If the capture device is a wireless device, such as a cellular data or WiFi device, the network includes a cellular telephone network or a wireless data network (e.g., cellular data, WiFi, WLAN, GPS, infrared, satellite, radio frequency, Bluetooth, or other). The network may, however, be any wired or wireless telecommunications communication link or network, or combination of such links and/or networks, or pluralities of different links or networks, for example, one or more of a packet-switched data network (e.g., Internet, intranet, local area network (LAN), wide area network (WAN) or virtual private network (VPN)), a circuit switched network (e.g., public switched telephone network (PSTN)), a cellular telephone network, or a wireless data network (e.g., cellular data, WiFi, WLAN, GPS, infrared, satellite, radio frequency, or other) linked to a centralized management system, such as the centralized management device 102 of FIGS. 1-3.

Note that the steps 802-806 may, as herein described, be repeated for each respective product, as indicated by steps 802n, 804n, and 806n. The steps 802-806 (and 802n, 804n, 806n), although performed by each relevant capture device, may be performed by more than one capture device. If more than one capture device, each capture device may be same or different or certain may be same or different. Each capture device in any event includes at least a camera for image capture, can operate the control unit to timestamp and perform communications over the network with the centralized management system, and communicates captured image and timestamp over the network to the centralized management system.

In a step 808, the image and timestamp is received over the network by the centralized management system. On receipt, the centralized management system creates a respective record for the product of the image in a step 810. The record includes the image and timestamp, and may additionally include other data representing the product, the dealer, the conditioning process(es), or other applicable information of the product and conditioning process for the product. For example, a tracking number or identifier may be included in the record for the product, such as may be assigned by the centralized management system to the product or otherwise assigned. The record is stored in a step 812 in a database.

Assuming the product must be conditioned (or reconditioned, as applicable), the product proceeds to a station or work group for a conditioning operation. On arriving at the station, a next image of the product is captured (either by same or different capture device from the original image) in the step 802 (or 802n). The captured image is timestamped by the applicable capture device in the step 804 (or 804n), and the image and timestamp are communicated by the capture device over the network in the step 806 (or 806n).

The image and timestamp are received from the network by the centralized management system in a step 814. The existing record for the product of the image and timestamp are obtained from the database by the centralized management system in a step 816. In a step 818, the record for the product is updated by addition of the further image and timestamp, as well as any relevant data assigned or directed by the centralized management system.

In a step 820, the centralized management system stores the updated record, for example, in memory of the centralized management system. In a step 822, the centralized management system calculates, assigns, or otherwise determines or designates an expected time frame for completion of conditioning at the station. If conditioning at additional or other stations is also required, the centralized management system may calculate, assign or otherwise determine time estimates for the other stations and work. Additional calculations and determinations can be made in the step 822 as may be desired in the application for the particular product and conditioning process. On completion of the step 822, the record is further updated in the step 824 and saved in the database.

Upon completion of the conditioning operation at the particular station, a next image of the product is captured by a capture device in a next of the step 802n, the image is timestamped in a next of the step 804n, and the image and timestamp are communicated over the network to the central management system in a next of the step 806n. The method returns to the step 814 of receiving the image and timestamp by the central management system, and continues through the steps 814-824 to update the record for the product.

At any point in the method 800, after a record is initially created for a product, a request may be made to the central management system, such as a request communicated over the network by any authorized manager device 110 of FIG. 1, for details about a particular product. In the step 826, on receipt of the request by the central management system, the central management system searches the database for the record of the applicable product (or, if applicable, records of the products) of the request, calculates any applicable efficiency or similar variables corresponding to the data of the record, and generates reports communicated to the requestor representing the product (or products). The authorization granted particular manager devices making requests to central management system may vary widely. For example, management-level personnel of the dealership may be provided access to reports of individual and aggregated information of station time, results, efficiency, worker time and efficiency, and other information, whereas sales-level personnel may be provided access to reports only of individual products relevant to the sales person. The central management system can include graphics features for representing various records and aggregates of records and information therein in a wide variety of manners. Of particular interest, can be the contents, and accessibility through request, in records of image data and timestamp for tracking conditioning processes, identifying products, and other analysis and details.

The method 800 continues with additional image capture, communicating of image and timestamp, and record updates, as well as reporting as requested by manager devices, for each product through the conclusion of the conditioning process at all stations for the product. Further records, and aggregated data of records, can be stored, and otherwise manipulated and calculations made, by the central management system, as may be dictated or desired by management or others in the particular application of the embodiments.

In general, the central management system and method, together with capture device(s) for collecting and communicating image and timestamp data for storage and organization by the central management system and related database, track each product, such as cars, and allows ready identification of the car and each operation/activity for the car, along each station of the stream. The systems and methods gather, organize, and store information of the car and each operation/activity for the car, and maintain these for each respective station.

According to certain embodiments, the central management system and method include a management software program (with database, communication features, processing, etc.) stored in a non-transitory memory of and operable on a desktop or server computer, accessible over a network by an authorized desktop computer or networked computer. The desktop or server computer and management software program can communicate through a network, such as or including Wi-Fi and/or cellular network, with capture devices, such as an iPhone, Android phone, tablet device, or other device, capable of communicating over the network or portions thereof with the central computer and software program. An application (or App) stored in non-transitory memory of the smartphone, tablet or other device allows worker(s) at each station to use such device to report to the central computer and program regarding the product and conditioning operation at each station and for the entire process for each product.

In certain non-exclusive alternatives to various embodiments, devices reporting to the central system can communicate additional data representing products, conditioning operations, and the like. For example, GPS units of devices can report locational information, additional data, such as notes, may be input to devices and reported, audio/dictation capability of devices can allow input of these types of notes or information for reporting, and other notes or information relevant to product, stations, and/or conditioning operations can be automatedly by the device or through input by the device user for reporting (e.g., weather stamp, estimates of needed time, sales details or criteria, lot or other damage conditions of products, strategies for conditioning, sales or otherwise, and other). Also in alternatives, the central management system, and its devices, elements, features, and operations, can vary as desired for the particular dealership or sale organization. For example, segregation of accessibility to data of records and/or aggregated records data can be directed or configured, such that particular devices or individuals can receive respective portions, reports and calculations of efficiency and performance can be varied among devices and individuals according to accessibility rules of the system, forms of requests and types of requests can be varied among devices and individuals (e.g., specific data vs aggregated data, or sets of records or data, whether specific or aggregated, or others), records and aggregated data reporting and output formats can be varied accordingly, and additional features or integration with third party software, devices, features and operations (e.g., spreadsheets, graphics, customer relationship management systems, inventory systems, accounting systems, and others) are possible.

Although this disclosure may at times refer to an image as being a photograph, the term “image” in respect of the embodiments is intended and should be construed in a broad sense as referring to any text, graphic, photograph, audio/dictation, or other human readable or perceptible descriptor (for example, notes, comments, drawings, location identifier, codes, or similar informational input or units) regarding a relevant product. In this regard, the terms “capture device”, “camera”, “capture system”, “camera device”, and similar input device can (as applicable in the context) mean or include any device capable of receiving a record (by capture, input or otherwise) of a feature or aspect of the relevant product, which device has applicable elements and operations as disclosed for handling and communicating such record.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, other advantages, and solutions to problems that have been described above with regard to specific embodiments are merely illustrative, the benefits, advantages, solutions to problems and devices, connections and elements that may cause any benefit, advantage, or solution to occur or become more pronounced are not to be construed as a critical, required, or essential feature or element of any or all the claims.

What is claimed is:

1. A system for monitoring a conditioning process for a product, the system configured to communicate over a data network, comprising:
a central computer for receiving product images and image timestamps of the product from the data network;
a database connected to the central computer, for storing product images and image timestamps received by the central computer;
a management unit communicatively connected to the central computer, the management unit creates and updates a respective record of the database for the product, responsive to receipts by the central computer.

2. The system of claim 1, further comprising:
a manager device communicatively connected to the central computer;
wherein the management unit, responsive to request of the manager device received by the central computer, communicates data to the manager device corresponding to the record then stored by the database for the product.

3. The system of claim 1, further comprising:
an image capture device communicatively connected to the central computer by the network, for communicating at least one of the product images and at least one of the image timestamps corresponding to the at least one of the product images, to the central computer over the network.

4. A method for monitoring a conditioning process for a product, comprising the steps of:
capturing a first image of the product;
timestamping the first image;
saving the first image, together with timestamp, in a record of a database;
capturing a second image of the product during the conditioning process;
timestamping the second image; and
saving the second image, together with timestamp, in the record of the database.

5. The method of claim 4, further comprising the steps of:
communicating the first image and timestamp over a network, in real time;
receiving the first image and timestamp;
creating the record in the database for the first image and timestamp;
communicating the second image and timestamp over the network, in real time;
receiving the second image and timestamp; and
updating the record in the database for the second image and timestamp.

6. The method of claim 5, further comprising the step of:
capturing a next image of the product at different time during the conditioning process;
timestamping the next image;
communicating the next image and timestamp over the network, in real time;
receiving the next image and timestamp;
updating the record in the database for the next image and timestamp; and
repeating the steps of capturing the next image, timestamping the next image, communicating the next image and timestamp, receiving the next image and timestamp, and updating the record in the database of the next image and timestamp, in succession and each at different time in the conditioning process until the conditioning process is completed.

7. The method of claim 6, further comprising the steps of:
receiving a request from a requestor over the network, for a data representing at least a portion of the record;
generating a report responsive to the request; and
communicating the report over the network to the requestor.

8. The method of claim 7, further comprising:
repeating the steps of receiving the request, generating the report, and communicating the report for the record as then-updated at the time of the step of receiving the request.
